(19) United States
(12) Patent Application Publication
(10) Pub. No.: US 2008/0042106 A1
(43) Pub. Date: Feb. 21, 2008

(54) Method for Marking Materials

(75) Inventors: Simon Champ, Ludwigshafen (DE); Sven Holger Behrens, Mannheim (DE); Werner A. Goedel, Ulm (DE); Mahendra Rane, Chemnitz (DE); To Ngai, Ludwigshafen (DE); Simon Nord, Romerberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/569,679

(22) PCT Filed: Jun. 2, 2005
(86) PCT No.: PCT/EP05/05924

§ 371 Date: Nov. 28, 2006

(30) Foreign Application Priority Data
Jun. 4, 2004 (DE) 10 2004 027 416.9
Apr. 27, 2005 (DE) 10 2005 019 980.1

(51) Int. Cl. G01N 31/00; C08K 7/16

(52) U.S. Cl. 252/408.1; 523/223

(57) ABSTRACT

The invention relates to a method for the marking of materials with coded microparticies, wherein coded microparticles which are obtainable by
(i) polymerization of at least one water-soluble monoethylenically unsaturated monomer in the presence of at least one ethylenically unsaturated monomer having at least two double bonds in the molecule by inverse water-in-oil suspension polymerization, doped nanoparticles being used as the suspending medium,
(ii) emulsion polymerization of water-insoluble monoethylenically unsaturated monomers with from 0 to 10% by weight, based on the monomer mixture, of at least one ethylenically unsaturated monomer having at least two double bonds in the molecule, doped nanopartices being used as an emulsifier for stabilizing the disperse phase,
(iii) polymerization of at least one ethylenically unsaturated monomer together with a copolymerizable dye which has an ethylenically unsaturated double bond, and, if appropriate, agglomeration of these partices or
(iv) agglomeration of at least two different groups of microparticles which differ in their absorption, emission and/or scattering of electromagnetic radiation to give aggregates having a mean particle diameter of from 300 μm to 500 μm
   are used, the use of the coded microparticles for the marking of materials and the materials marked with the microparticles.

The invention relates to a method for the marking of materials with coded microparticles.

U.S. Pat. No. 3,772,099 discloses the coding of explosives with the aid of an inorganic luminescent material, for example a finely divided, commercial luminescent material and a finely divided luminescent substance doped with at least one element of the lanthanide group of the periodic table being mixed with an aqueous potassium silicate solution and the mixture being dried, milled and sieved. The particle size of the conglomerate thus formed is form 0.5 to 0.7 mm, while the particle size of the luminescent materials is in the range from 6 to 8 μm. Such a conglomerate can, for example, be carefully mixed with the explosive during the preparation of dynomite. Amounts as low as 0.01% by weight are sufficient for marking an explosive. Even after detonation, on the basis of collected samples, the explosives marked in this manner can be identified with the aid of the emission lines which the coded luminescent materials emit, for example, on exposure to ultraviolet light. Owing to the different doping by luminescent materials, there is a large number of possible combinations so that the manufacturer, the year, the month and the week of manufacture of an explosive marked in a suitable manner with a plurality of doped luminescent materials can be determined.

U.S. Pat. No. 4,390,452 discloses coded microparticles for the retrospective identification of substances which comprise such microparticles. The coded microparticles are obtained by applying visually distinguishable color layers in succession according to the teaching of DE-A_26 51 528 to a substrate film, and producing, on the surface of the composite with the aid of a diazotization process, a very thin layer in which, as a result of exposure to UV light which is incident on this layer through a microdata-comprising positive, numbres and symbols which can be microscopically evaluated are present after development. Microparticles which are no larger than 1000 μm and which have two flat, parallel surfaces which comprise the applied numbers and symbols are produced from the coating. The microparticles are used for the marking of substances, for example explosives, in order retrospectively to detect the origin and production data on the product.

WO-A-03/044276 relates to a security paper and security article having at least one security element based on at least one photoluminescent segment which is at least partly incorporated in a paper product which consists of from 30 to 99% by weight of dry fibers and from 70 to 1% by weight of filler. The security element can be produced, for example, by coloring a substrate of cellulose fibers with a photoluminescent dye. The photoluminescence becomes visible if the security element is exposed to light having a wavelength of from 200 to 500 nm,

WO-A-03/052025 discloses nanoparticle-comprising printing inks for inkjet printers or piezo printers. The rnanoparticles have a diameter of from 1 to 1000 nm and have a crystal structure. They substantially comprise a doped metal salt, for example nanoparticles of YVO₄ doped with euridium or LaPO₄ doped with cerium. The nanopartic es may also be doped with a plurality of elements, for example LaPO₄ doped with cerium and terbium. With such printing inks, for example, bank notes which were printed therewith can be made forgery-proof.

WO-A-02/46528 discloses the application of a marking serving for security as a coating to a substrate such as paper, ceramic or polymer, the binder of the coating material comprising fluorescent microparticles having a diameter of from 0.2 to 2 μm and discrete particles optically distinguishable therefrom and having a diameter of from 10 to 20 μm. When viewed with the naked eye, the coating appears to have a uniform color, but under high magnification the discrete particles can be distinguished on the basis of color from the particles having a diameter of from 0.2 to 2 μm.

U.S. Pat. No. 6,620,360 discloses a process for the production of multilayer microparticles for the marking and for the subsequent identification of substances, which comprise these microparticles. The microparticles are produced by applying a plurality of thin and visually distinguishable marking layers in succession to a sheet-like substrate, the thickness of a marking layer after the layer has become solid being from less than 4.5 μm to 1 μm, before the next layer is applied. The sheetlike substrate is then removed and the composite of marking layers is comminuted to give a powder.

U.S. Pat. No. 6,455,157 discloses the use of at least two different groups of microparticles for the marking of products, each microparticle of a group comprising a plurality of color layers which form a code. A hierarchical coding of products is possible with the aid of these microparticles, so that, for example, the manufacturer and the product number can be detected on the marked products.

In Chem, Commun., 2002, 1435-1441, B. J. Battersby, G. A. Lawrie, A. P. R. Johnston and M. Trau report on optical coding of colloidal suspensions with fluorescent dyes, nanocrystals and metals. Thus, for example, coloids having a diameter of from 3 to 6 μm were optically marked by incorporating fluorescent dyes or lanthanides bound in the form of a complex. Another method of marking colloids consists in the incorporation of zinc sulfide which is provided with cadmium selenide nanocrystals or in the electrochemical deposition of metal ions in cavities of colloids. The colloids can be distinguished from one another, for example, with the aid of a fluorescence microscope or of a cytometer.

The object of the present invention is to provide further markings for materials.

The object is achieved, according to the invention, by a method for the marking of materials with coded microparticles if coded microparticles which are obtainable by
(i) polymerization of at least one water-soluble monoethylenically unsaturated monomer in the presence of at least one ethylenically unsaturated monomer having at least two double bonds in the molecule by inverse water-in-oil suspension polymerization, doped nanoparticles being used as the suspending medium,
(ii) emulsion polymerization of water-insoluble monoethylenically unsaturated monomers with from 0 to 10% by weight, based on the monomer mixture, of at least one ethylenically unsaturated monomer having at least two double bonds in the molecule, doped nanoparticles being used as an emulsifier for stabilizing the disperse phase,
(iii) polymerization of at least one ethylenically unsaturated monomer together with a copolymerizable dye which has an ethylenically unsaturated double bond, and, if appropriate, agglomeration of these particles or
(iv) agglomeration of at least two different groups of microparticles which differ in their absorption, emission andlor scattering of electromagnetic radiation to give aggregates having a mean particle diameter of from 300 nm to 500 μm are used.

For example, nanoparticles which are doped at least with a dye or with a compound from the group consisting of the rare earth elements of the Periodic Table or radioactively doped are used in the polymerization according to (i) and (ii).

The mean particle diameter of the polymer particles which are obtainable by polymerization according to (i) is, for example, from 0.1 μm to 1000 μm, preferably from 0.5 μm to 50 μm. in general, the mean particle diameter of the microparticles prepared according to (i) is in the range from 1 μm to 20 μm. The preparation of particulate polymers by the method of inverse water-in-oil suspension polymerization (ISP), nanoparticles being used as the suspending medium, is disclosed, for example, in U.S. Pat. No. 2,982,749, column 1, line 21 to column 6, line 34. Examples of such suspending media which have a low hydrophilic-lipophilic balance (i.e. HLB value of less than 7, preferably less than 4) are silanized silicas, bentonites or clays, each of which have been treated with quarternary ammonium compounds, and organic nanoparticies, such as partly sulfonated polyvinyltoluene or chlorovinyltoluene polymers reacted with dimethylamine. For the definition of the HLEB value, reference is made to W. C. Griffin, Journal of the Society of Cosmetic Chemists, Volume 1, 311 (1950).

Further nanoparticles which are suitable as suspending media are CaCC₃, BaSO₄, barium titanate, SiO₂ oxides, sulfides, phosphates and pyrophosphates of alkaline earth metals and transition metals, in particular zinc oxide, titanium dioxide, iron oxide (goethite, hematite), iron sulfide and barium pyrophosphate, and furthermore polymer particles, for example of polystyrene or polyacrylates, and mixtures of two or more nanoparticles, for example mixtures of zinc oxide and titanium dioxide. The mean particle diameter of the nanoparticles is, for example, from 5 to 500 nm and in general in the range from 20 to 300 nm.

An overview of the stabilization of emulsions with colloidal particles and further suspending media for the ISP is to be found in R. Aveyard, B. P. Binks and J. H. Clint, Advances in Colloid and Interface Science, Volume 100-102, pages 503-546 (2003). In addition, reference is made to the publication by E. Vignati and R. Piazza, Langmuir, Vol. 19, No. 17, 6650-6656 (2003), on Pickering emulsions. The nanoparticles which are used in the ISP for the preparation of the microparticles to be used according to the invention are doped, prior to the polymerization, with a dye, preferably with a fluorescent dye, an element or a compound of the rare earth elements of the Periodic Table or a radioactive compound or a radioactive element. Even very smalI amounts are sufficient for this purpose, so that identification of the doped particles with the aid of the determination of the absorption, emission or scattering of electromagnetic radiation is possible. Nanoparticles which are doped with at least one fluorescent dye are preferred, for example nanoparticles of polystyrene having a mean particle diameter of from 20 to 300 nm and a fluorescent dye, nanoparticles of silica having a mean particle diameter of from 20 to 100 nm and at least one fluorescent dye. In addition, silica particles having said diameter and doped with lanthanum and/or terbium and/or cerium are suitable for the ISP for stabilizing the emulsion.

Examples of dyes which can be used according to the invention are
(a) water-insoluble dyes:

| | |
|---|---|
| Fluorol 7GA | Lambdachrome No. 5550 (Lambda Chrom Laser Dyes |
| | from Lambda Physik GmbH, Hans-Böckler-Str. 12, |
| | Göttingen) |
| Coumarin 47 | CAS Reg. No. 99-44-1 |
| Coumarin 102 | CAS Reg. No. 41267-76-9 |
| Coumarin 6H | CAS Reg. No. 58336-35-9 |
| Coumarin 30 | CAS Reg. No. 41044-12-6 |
| Fluorescein 27 | CAS Reg. No. 76-54-0 |
| Uranin | CAS Reg. No. 518-47-8 |
| Bis-MSB | CAS Reg. No. 13280-61-0 |
| DCM | CAS Reg. No. 51325-91-8 |
| Cresyl Violet | CAS Reg. No. 41830-80-2 |
| Phenoxazon 9 | CAS Reg. No. 7385-67-3 |
| HITCI | CAS Reg. No. 19764-96-6 |
| I R 125 | CAS Reg. No. 3599-32-4 |
| I R 144 | CAS Reg. No. 54849-69-3 |
| HDITCI | CAS Reg. No. 23178-67-8 |
| Carbostyryl 7 | Lambdachrome ® No. 4220 (Lambda Physik GmbH) |
| Carbostyryl 3 | Lambdachrome No. 4350 (Lambda Physik GmbH) |

(b) water-soluble dyes

| | |
|---|---|
| Rhodamine B | CAS Reg. No. 81-88-9 |
| Rhodamine 101 | CAS Reg. No. 64339-18-0 |
| Rhodamine 6G | CAS Reg. No. 989-38-8 |
| Brillantsulfaflavin | CAS Reg. No. 2391-30-2 |
| Rhodamine 19 | CAS Reg. No. 62669-66-3 |
| Rhodamine 110 | CAS Reg. No. 13558-31-1 |
| Sulforhodamine B | CAS Reg. 2609-88-3 |
| Nile Blue | CAS Reg. 53340-16-2 |
| Oxazine | CAS Reg. 62669-60-7 |
| Oxazine 1 | CAS Reg. No. 24796-94-9 |
| HIDCI | CAS Reg. No. 36536-22-8 |
| Cryptocyanine | CAS Reg. No. 4727-50-8 |
| Furan 1 | Lambdachrome ® No. 4260 (Lambda Physik GmbH) |
| Stilbene 3 | Lambdachrome ® No. 4200 (Lambda Physik GmbH) |
| DASBTI | Lambdachrome ® No. 5280 (Lambda Physik GmbH) |

c) reactive dyes

| | |
|---|---|
| DACITC* | CAS Reg. No. 74802-04-3 |
| DMACA, SE* | CAS Reg. No. 96686-59-8 |
| 5-FAM, SE* | CAS Reg. No. 92557-80-7 |
| FITC ‘Isomer I’* | CAS Reg. No. 3326-32-7 |
| 5-TRITC; G isomer* | CAS Reg. No. 80724-19-2 |

*these dyes react, for example, with NH groups

In order to prepare virtually water-insoluble polymer particles (the solubility of the polymers in water is <1 g/l, preferably <0.1 gl, at 20° C.) by the ISP process, water- soluble monoethylenically unsaturated monomers are copolymerized together with monomers which have at least two double bonds in the molecule according to (i). Examples of water-soluble monomers are ethylenically unsaturated C₃- to C₆- carboxylic acids, such as acrylic acid, methacrylic acid, crotonic acid, maleic acid, itaconic acid, vinyllactic acid and ethacrylic acid, and acrylamido-2-methylpropanesulfonic acid, vinylsulfonic acid, styrenesulfonic acid, vinyltoluenesulfonic acid and vinylphosphonic acid. The ethylenically unsaturated acids can also be used in a form partly or completely neutralized with alkali metal or alkaline earth metal bases or with ammonia or ammonia compounds, Sodium hydroxide solution, potassium hydroxide solution or ammonia is preferably used as the neutralizing agent. Further suitable water-soluble monomers are acrylamide and methacrylamide. The monomers can be used alone or as a mixture with one another and together with up to 20% by weight of water-insoluble monomers, such as acrylonitrile, methacrylonitrile or acrylates and methacrylates.

Examples of the monomers used as crosslinking agents in the ISP and having at least two double bonds are N,N′-methylenebisacrylamide, divinylbenzene, divinyidioxane, acrylates and methacrylates of at least dihydric alcohols, such as ethylene glycol, propylene glycol, butylene glycol, hexanediol, glycerol, pentaer thritol and sorbitol and po yalkylene glycols having molar masses M_{N} of from 100 to 3000, in particular polyethylene glycol and copolymers of ethylene oxide and propylene oxide. Preferably used crosslinking agents are butane-1,4-diol diacrylate, butane-1,4-diol dimethacrylate, hexane-1,6-diol diacrylate, hexane-1,6-diol dimethacrylate, di- and triallyl ethers of pentaerythritol or sorbitan triallyi ether, The crosslinking agents are used in the iSP, for example, in an amount of from 0.01 to 10% by weight, preferably from 0.5 to 5% by weight, based on the total amount of monomers used. It is of course possible to use two or more crosslinking agents in the polymerization.

In the 1SP, the nanoparticies preferably doped with a dye are used, for example, in an amount of from 0.01 to 20% by weight, preferably from 0.1 to 5% by weight, as a stabilizer for the emulsion. The microparticles forming in the polymerization comprise the doped nanoparticies preferably on the surface. The microparticies can be isolated from the suspension, for example by breaking the suspension or by removing the volatile solvents.

Another method for the preparation of coded microparticles comprises (ii) the emulsion polymerization of water-insoluble monoethylenically unsaturated monomers with from 0 to 10% by weight, based on the monomer mixture, of at least one ethylenicaily unsaturated monomer having at least two double bonds in the molecule, the emulsifier used for stabilizing the disperse phase likewise being doped nanoparticles in the amounts which are also used in the ISP according to (i). The doped nanoparticies are found in or on the surface of the resulting emulsion polymers. Emulsion polymerization processes are known. Here, for example, water-insoluble monomers are polymerized in the presence of free radical initiators, such as sodium persulfate, hydrogen peroxide or redox catalysts, to give a finely divided polymer dispersion. For stabilizing the emulsion, compounds having an HLB value of >7 are usually used. Such compounds are, for example, C₁₂- to C₁₈-alcohols which are reacted, for example, with from 5 to 50 mol of ethylene oxide per mole of alcohol, or the alkali metal salts of sulfonated long-chain (>C₁₂-) alcohols. The emulsifiers are, if appropriate, used according to (ii). If they are concomitantly used, their amount is, for example, from 0.1 to 10, preferably from 0.5 to 3, % by weight, based on the monomers to be polymerized.

Water-insoluble monomers are to be understood as meaning those ethylenically unsaturated compounds which form water-insoluble polymers. The water solubility of the water-insoluble polymers is, for example, <1 g/l, in general <0.01 g/l. Examples of such monomers are styrene, g-methylstyrene, esters of acrylic acid and methacrylic acid with monohydric C₁- to C₁₈-alcohols, preferably C₁- to C₄-alcohols, acrylamides substituted by C₁- to C₂₀-alkyl groups and also N-substituted methacrylamides, such as N-methylacrylamide, N-methyl methacrylamide, N-ethylacrylamide and N-ethylmethacrylamide.

The water-insoluble monomers can, if appropriate, be copolymerized with small amounts of water-soluble monomers, the water-soluble monomers being used only in an amount such that the resulting polymers are water-insoluble. If water-soluble monomers are used for modifying the water-insoluble polymers, the amount used in the emulsion polymerization is, for example, from 0.1 to 10, preferably from 0.2 to 5, % by weight. Water-soluble monomers which may be used are the monomers described above under (i), such as, in particular, ethylenically unsaturated acids. Modification of the polymers may be necessary, for example, in order to introduce functional groups into the polymer so that it can, for example, be subjected to subsequent reactions.

In some cases, it may be necessary to reduce the solubility of the polymers in water and to increase the strength properties of the polymer. This aim is achieved by carrying out the polymerization of the water-insoluble monomers in the presence of ethylenically unsaturated monomers which comprise at least two double bonds in the molecule.

Such monomers, which are also referred to as crosslinking agents, are mentioned above under (i). They are used in the emulsion polymerization according to (ii) in the same amounts as described above for the ISP. Examples of crosslinked emulsion polymers are polystyrenes which have been crosslinked with divinylbenzene or butanediol diacrylate, and acrylates and methacrylates crosslinked with pentaerythrityl triacrylate and/or pentaerythrityl tetraacrylate, such as crosslinked poly(n-butyl acrylate) or crosslinked poly(methyl methacrylate).

The mean particle diameter of the polymers which are obtainable by polymerization according to (ii) is, for example, from 10 nm to 1000 μm, preferably from 10 nm to 10 μm. It is in general in the range from 500 nm to 30 μm, in particular from 1 μm to 20 μm. The aqueous polymer dispersions prepared according to (ii) comprise microparticles which are doped with nanoparticles and are dispersed in water. The doped microparticles can be obtained from the aqueous polymer dispersion by centrifuging or destabilization of the dispersion by addition of inorganic salts. Since the microparticles are used for most applications in dispersed form, the isolation of microparticles from aqueous dispersions is only of minor importance.

Coded microparticies are moreover obtainable by subjecting at least one ethylenically unsaturated monomer to a free radical polymerization together with a copolymerizable dye which has an ethylenically unsaturated double bond, according to (iii). Examples of dyes which comprise an ethylenically unsaturated double bond are 4-(dicyanovinyl)julolidine (DCVJ) and trans-1-(2′-methoxyvinyl)pyrene. These dyes can be used, for example, in the inverse suspension polymerization (i) and the emulsion polymerization (ii) as comonomers for the coding of polymer particles. Particularly when polymer particles having a mean particle diameter of from 5 to 500 nm are obtained, it may be advantageous when using coded microparticles to agglomerate the particles into aggregates having a mean particle diameter of, for example, from 300 nm to 500 μm.

Coded microparticles can also be prepared by agglomerating at least two different groups of microparticles, which differ in their absorption, emission and/or scattering of electromagnetic radiation, into aggregates having a mean particle diameter of from 300 nm to 500 μm, preferably from 400 nm to 20 μm, according to (iv). Thus, for example, silica particles coded with a fluoresc nt dye and having a mean diameter of from 5 to 500 nm, preferably 20-100 nm, and a crosslinked polystyrene which is modified with amino groups (use of, for example, from 0.5 to 3% by weight of dimethylaminopropyl acrylate in the polymerization of styrene), has a mean particle diameter of from 20 to 100 nm and is doped with one of the abovementioned reactive dyes, for example the dye having the CAS Reg. No. 96686-59-8, can be combined into an agglomerate which has a mean particle size of, for example, from 300 nm to 500 μm, preferably from 400 nm to 20 μm.

Coded microparticles whose coding comprises in each case at least two different dyes are preferred. In order to increase the number of pieces of information, for example, a mixture of two groups of coded micropanicles is used, the mixture comprising a group of coded microparticles comprising only one fluorescent dye and another group of coded microparticles comprising two thereof and fluorescent dyes differing from one another.

The number of pieces of information can be increased by using a mixture of two groups of coded microparticles for the marking of materials, the mixture comprising one group of coded microparticles comprising, for example, only one fluorescent dye and another group of coded microparticles comprising two reactive dyes differing from one another. For example, it is also possible to use a mixture of two groups of coded microparticles, the mixture comprising a group A of coded microparticles comprising one fluorescent dye and another group B of coded microparticles comprising three or more fluorescent dyes differing from one another and differing from the dye of group A.

A further example for the marking of materials is a mixture of two groups of coded microparticles A and B, the mixture comprising a group of coded microparticles A comprising two different fluorescent dyes and another group of coded microparticles B comprising two fluorescent dyes differing therefrom.

An example for further markings is a mixture of two groups of coded microparticles A and B, the mixture comprising a group of coded microparticles A comprising two different fluorescent dyes and another group of coded microparticles B comprising three or more fluorescent dyes differing therefrom, A further example is a mixture of two groups of coded microparticles A and B, the mixture comprising one group of coded microparticles A comprising three different fluorescent dyes and another group of coded microparticles B comprising three fluorescent dyes differing therefrom.

Another example for a coding which comprise five different groups of microparticles A-E is a mixture comprising

A a group of microparticles comprising three different dyes D1, D2 and D3,

B a group of microparticles comprising the dyes D1 and D2,

C a group of microparticles comprising the dyes D1 and D3,

D a group of microparticles comprising the dyes D4 and D5 and

E a group of microparticles comprising the dye D4.

The invention also relates to the use of coded microparticles which are obtainable by
(i) polymerization of at least one ethylenically unsaturated monomer in the presence of dyes and/or nanoparticles which, if appropriate, are doped with at least one dye or with an element of the group consisting of the rare ear h elements of the Periodic Table or radioactively doped to give microparticies having a mean particle diameter of from 300 nm to 500 μm or
(ii) agglomeration of at least two different groups of microparticles which differ in their absorption, emission and/or scattering of electromagnetic radiation to give aggregates having a mean particle diameter of from 300 nm to 500 pm,
   a combination of at least two different groups of coded microparticles which differ in their absorption, emission and/or scattering of electromagnetic radiation always being used for the marking of materials.

Microparticles coded with fluorescent dyes and microparticles coded with reactive dyes are particularly preferably used. The microparticles coded with water-soluble dyes and the microparticles coded with water-insoluble dyes are furthermore important.

The identification of the coded microparticles is possible with the aid of commercial cytometers in which a fluorescence spectrometer and/or photodetectors having suitable filters are installed. The identification of the coded microparticies is effected, for example, by analysis of the total fluorescence spectrum or of the emitted radiation of individual selected wavelengths, it also being possible to var the wavelength of the incident light which gives rise to the fluorescence. Cytometers which are suitable for identifying coded microparticles are sold, for example, by Partec GmbH, Otto-Hahn-Str. 32, D-48161.

The coded microparticles described above are used for the marking of materials, for example for dispersions, coatings, paints, explosives, polymers, crop protection agents, seed, pharmaceutical products, such as tablets, capsules, tinctures or preparations containing active substances, cosmetic products, such as creams, lotions or shampoos, solutions, such as fuels and in particular heating oil, paper, in particular paper packagings, bank notes and security papers, and all articles which are provided with a code, such as chassis numbers of motor vehicles.

The invention also relates to materials which comprise microparticles coded for marking and are obtainable by
(i) polymerization of at least one water-soluble monoethylenically unsaturated monomer in the presence of at least one ethylenically unsaturated monomer having at least two double bonds in the molecule by inverse water-in-oi suspension polymerization, doped nanoparticies being used as the suspending medium,
(ii) emulsion polymerization of water-insoluble monoethylenically unsaturated monomers with from 0 to 100% by weight, based on the monomer mixture, of at least one ethylenically unsaturated monomer having at least two double bonds in the molecule, doped nanoparticles being used as an emulsifier for stabilizing the disperse phase,
(iii) polymerization of at least one ethylenically unsaturated monomer together with a copolymerizable dye which has an ethylenically unsaturated double bond, and, if appropriate, agglomeration of these particles or
(iv) agglomeration of at least two different groups of microparticies which differ in their absorption, emission and/or scattering of electromagnetic radiation to give aggregates having a mean particle diameter of from 300 nm to 500 pm.

If two groups of microparticles having a different code are combined, a composition by means of which complex or hierarchical markings are possible is obtained. These mixtures can provide a wide range of information by analyzing them, for example, with the aid of fluorescence microscopy. The information present in the mixtures can be read from the absorption, emission or scattering spectrum of the various fluorescent materials with the aid of the known methods, which are described, for example, in the literature references stated in connection with the prior art

Thus, it is possible, for examp e, to store a considerable number of pieces of information by a combination of differently coded microparticies or by the use of a plurality of fluorescent substances for coding a microparticle. f, for example, the microparticles coded in this manner are added to a product to be marked, for example, manufacturer, production location, date of manufacture and batch number can be detected from the absorption, emission or scattering spectrum of a sample of the marked product.

When used as a coding composition, the coded microparticles must of course be compatible with the materials to be coded, i.e. neither the desired product properties nor the redetectabiity of the coded microparticies may be impaired.

1-15. (canceled)

16. A mrethod for the marking of aterials with coded mnicroparticles said coded microparticles being obtained by either
(i) polymerzation of at east one water-soluble monoethylenicallv unsaturated rnonmer in the presence of at least one ethylenically unsaturated rmonomer having at least two double bonds in the molecule by inverse water-in-oil suspension pol yerization wherein doped nanoparticles are used as the suspending medium,
(ii) emulsion polymerization of water-insoluble monoethylenically unsaturated monomers with from 0 to 10% by weight, based on tne monomer mixture, of at least one ethylenically unsaturated monomner having at least two double bonds in the molecule wherein doped nanoparticles are used as an emulsifier for stabilizing the disperse phase, or
(iii) polymerizatio of at l east one ethylenicallv unsaturated monomer together with a copol merizable dye which has an ethyle nicalv unsaturated double bond, and
optionally, ag- omeration of these particles.

17. The method according to claim 16, wherein nanoparticles which are doped at least with a dye or with a compoun d fro ne group consisting of he rare earth ele ents of the Periodic Table or radioactively doped are used in the polynerization according to (i) and (ii).

18. The method according to claim 16, wherein the mean particle diameter of the poly er particles which are obtained by polymerization according to (i) is from 0.1 μm to 1000 μm.

19. The method according to claim 16, wherein the mean particle diameter of the polymer particles which are obta ned by pol erization according to (i) is from 0.5 μm to 50 μm.

20. The method according to claim 16, wherein the mean particle diameter of the polymer particles which are obtained by polymerization according to (i) is from 1 μm to 20 μn.

21. The method according to claim 16, wherein the mean particle diameter of the pol ner particles which are obtained by poly erization accord ing to (ii) is from 10 nm to 1000 μm.

22. The method according to claim 16, wherein the mean particle diameter of the polymer particles which are obtained by polymerization according to (I.) is from 500 nm to 30 μm.

23. The method according to claim 16, wherein the mean particle diameter of the polyer particles which are obtained by olynerization according to (ii) is from 1 μm to 20 μm.

24. The method according to claim 16, wherein at least two different groups of microparticles which differ in their absorption, emission and/or scattering of electromagnetic radiation are used as the coded microparticles.

25. A material which comprises microparticles coded for marking, said microparticles being obtained by either
(i) polymnerization of at least one water-soluble monoeethylenically unsaturated mnom er in the presence of at least one ethylenically unsaturated monomer having at least two double bonds in the molecule by inverse water-in-oil suspension polymerization wherei doped nanoparticles are used as the suspending medium,
(ii) emulsion polymerization of water-insoluble monoethylenically unsaturated monomers with from 0 to 10% by weight, based on the monomer mixture, of at least one ethylenicallv unsaturated monomer having at least two double bonds in the molecule wherein doped nanoparticles are used as arl emulsifier for stabilizing the disperse phase, or
(iii) polymerization of at least one ethvienicaliy unsaturated monomer together with a copolvrnerizable dye which has an ethylenically unsaturated double bond, and
optionally, agglomeration of these particles.

26. A method of using coded microparticles for the marking of materials. said coded microparticles being obtained by
polymerization of at least one ethylenically unsaturated monomer in the presence of dyes anid/or nanoparticles which are doped with at least one dve or with an element of the group consisting of the rare earth elements of the Periodic Taole or radioactively doped to ive microparticles having a mean panticle diameter of from 300 nm to 500 μm,
wherein said method comprises utilizing a combination of at least two different groups of coded micropartic es which differ in their absorption, emission and/or scattering of electromagnetic radiation.

27. The method according to claim 26, wherein microparticles coded with fluorescence dyes are used.

28. The method according to claim 26, wherein microparticles coded with reactive dyes are used.

29. The method according to claim 26, wherein micropartieles coded with water-soluble dves are used.

30. The method according to claim 26, wherein microparticles coded with water-insoluble dyes are used.
